(19) United States
(12) Patent Application Publication
(10) Pub. No.: US 2022/0281384 A1
(43) Pub. Date: Sep. 8, 2022

(54) STEP ACCESS TO A VEHICLE FROM THE FRONT

(71) Applicants: Robert Felice Mori, Palo Alto, CA (US); Philip Gabriel Yurkonis, Campbell, CA (US)

(72) Inventors: Robert Felice Mori, Palo Alto, CA (US); Philip Gabriel Yurkonis, Campbell, CA (US)

(21) Appl. No.: 17/195,017

(22) Filed: Mar. 8, 2021

(51) Int. Cl. B60R 3/02

(52) U.S. Cl. CPC B60R 3/02

(57) ABSTRACT

A step system for access to the interior of an electric vehicle is disclosed. The apparatus is located at the front center of the vehicle. Advantageously, the access is for both driver and passengers, allowing close proximity for the driver to reach a seated position from outside the vehicle. In addition, eliminating multiple doors and having one entry point saves construction cost. Access is provided between the front headlights or front left and right wheels, unobstructed by an engine compartment which is typically absent in an electrically powered vehicle. Steps rotate down to provide convenient access from ground level. In the closed position, the step apparatus integrates into the front body of the vehicle thus enabling the vehicle to operate unobstructed.

### FIELD OF THE INVENTION

The invention relates generally to electric vehicle access and to a stepping assist for onboarding. In particular, a rotating vehicle step apparatus which rotates down from a closed position to an open position in which it functions as a step assist to facilitate access to the interior of the vehicle.

### BACKGROUND OF THE INVENTION

Unlike a typical bus door design, where the passenger access door is located on the curb side of the vehicle, this disclosure describes vehicle access which is located at the front center of the vehicle. In this disclosure, the location of the step apparatus used for access is centrally located between the driver and front passenger. Front access is possible in an electric vehicle since there is no combustion engine occupying the area used by the step apparatus.

In other related art, vehicles such as trucks provide a fixed, adjustable, or retractable stepping assist to allow access to the cargo bed of the truck.

Recreational vehicles (RVs) provide a similar mechanism for access to the interior, typically located at the side of the vehicle.

Similarly, light aircraft doors have embedded stairs that deploy when the door is opened.

In regions of the world where there is a difference between right hand drive and left hand drive, with our invention, the driver and passenger sides can switch without any change to the location of the front access point.

### SUMMARY OF THE INVENTION

A rotating vehicle step apparatus that is located at the front portion of a vehicle is described. The deployed vehicle steps facilitate access to the interior of the vehicle.

The vehicle step apparatus has a latch and interlock mechanism that keeps the apparatus in a closed position when the vehicle is in motion.

The vehicle step apparatus has a hinge mechanism to allow the unlatched steps to rotate down into an open position suitable for onboarding passengers.

### BRIEF DESCRIPTION OF THE DRAWINGS

FIG. 1 shows the vehicle with step apparatus in the closed position, suitable for driving.

FIG. 2 shows the stepping apparatus deployed after first being unlatched and then in a rotating manner, coming to rest slightly above the road surface, open and ready to be used for boarding the vehicle.

FIG. 3 shows a cross-section of the vehicle with the step apparatus in the closed position.

FIG. 4 shows a cross-section of the vehicle with the step apparatus in the open position.

### DETAILED DESCRIPTION OF THE PREFERRED EMBODIMENT

Disclosed herein is a stepping structure for assisting a user to access the interior of a vehicle, where the access point is located at the front of the vehicle.

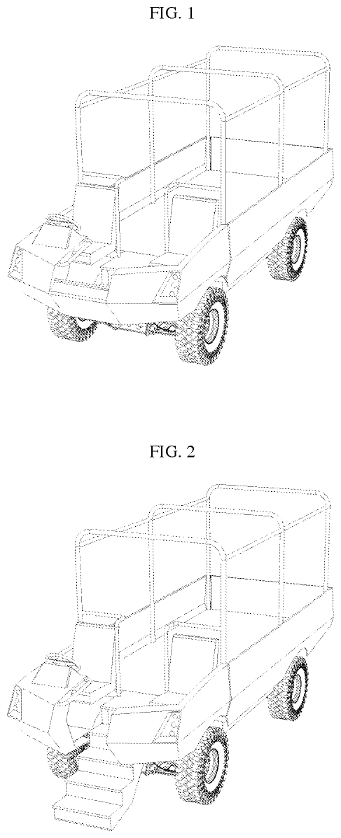

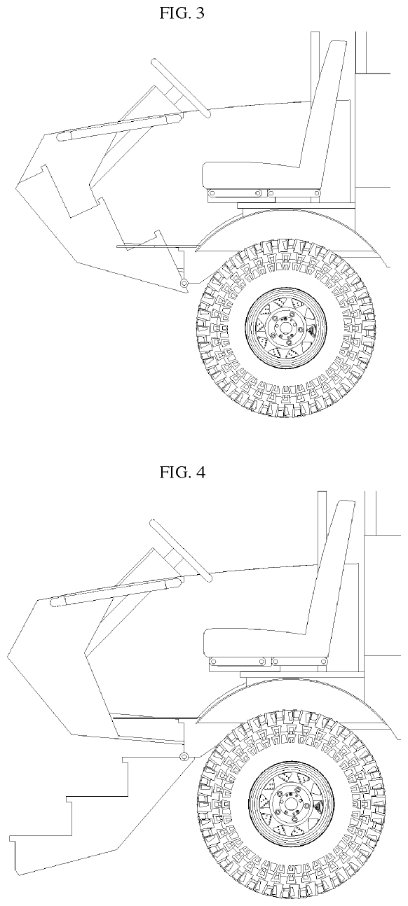

In particular the stepping structure can move from closed to an open position and thus can be advantageous for use in high ground clearance vehicles, such as those used for off-road travel. FIG. 1 and FIG. 3 illustrate a step apparatus in the closed position. In the closed position, the vehicle operates normally with the stepping apparatus latched. When deployed as shown in FIG. 2 and FIG. 4, the steps, which comprise a rigid section with stepping members, are rotated down using a hinge at the vehicle body frame. Vertical motion of the stepping apparatus is limited by the ground height or by a stop, optionally located at the rear of the hinge.

Opening and closing of the stepping apparatus may be aided by springs or a counter balance and may be operated manually or automatically with an electric motor or lift-gate strut.

Optionally, a handrail or grab handles can be located at the interior of the vehicle to support passenger stability as they enter the vehicle.

Variations and modifications to the disclosed embodiment may become apparent to those skilled in the art and fall within the scope of the invention.

### REFERENCES

Yada; Wataru, and Yamanouchi; Hiroshi. Boarding ramp device for aircraft. U.S. Pat. No. 7,677,494 filed Oct. 27, 2006, and issued Mar. 16, 2010
Uemura; Takuya, and Shigeiri; Naoto. Work vehicle. U.S. Pat. No. 10,005,397 filed Feb. 16, 2016, and issued Jun. 26, 2018
Brooks, Jr.; Paul, and Teeters; Clarence O. Mounting step for automotive vehicle. U.S. Pat. No. 3,734,534 filed Apr. 22, 1971, and issued May 22, 1973
Medsker; James A. Articulating step assembly. U.S. Pat. No. 6,659,224 filed Oct. 11, 2001, and issued Dec. 9, 2003
Nania; Adrian. Vehicle step system. U.S. Pat. No. 9,434,317 filed Nov. 13, 2014, and issued Sep. 6, 2016
Paschke; Joachim, von Mayenburg; Michael, Novoa; Louis A., Good; Ducan, Blakewood; Charles H., Hurayt; Mark S. Retractable stairway for entering and exiting a vehicle. U.S. Pat. No. 6,179,312 filed Mar. 14, 1997 and issued Jan. 30, 2001

1. A stepping apparatus located at the front of an electric vehicle comprising:
a. a housing of one or more adjoining steps designed for supporting a human foot
b. a hinge located at one end of the steps and attached to the base of the vehicle
c. a latching handle at the other end of the steps used to secure the steps in a closed position suitable when operating the vehicle.

2. A stepping apparatus according to claim 1, wherein the hinge apparatus allows articulation between an open and closed position, and when in an open position, makes use of a stop to prevent the steps from over articulating, and when in a closed position, makes use of a latch and interlock mechanism to secure the steps to the vehicle such as is necessary when the vehicle is in motion.

3. A stepping apparatus according to claim 2, wherein the open and close motion is aided by mechanical and/or electrical assists to promote ease-of-use.
